(19) United States
(12) Patent Application Publication
(10) Pub. No.: US 2002/0104259 A1
(43) Pub. Date: Aug. 8, 2002

(54) Method and device for the controlled delivery of herbicides and pesticides

(76) Inventors: Arthur M. Tofani JR., Conshohocken, PA (US); Arthur M. Tofani III, Conshohocken, PA (US)

Correspondence Address: Frank J. Bonini, JR., 86 The Commons At Valley Forge East, 1288 Valley Forge Road, P.O. Box 750, Valley Forge, PA, 19482-0750, US

(21) Appl. No.: 09/975,369

(22) Filed: Oct. 11, 2001

Related U.S. Application Data
(63) Continuation-in-part of application No. 09/689,459, filed on Oct. 12, 2000.

(51) Int. Cl. A01C 1/00; A01G 1/00

(52) U.S. Cl. 47/1.5

(57) ABSTRACT

Herbicide device and method of applying a herbicide to remove unwanted vegetation growth, the herbicide device having a reservoir, a valve unit, an applicator and a safety cover with a child-proof locking feature to securably contain the herbicide in the reservoir when the device is not in use, the method including the steps of providing herbicide in a reservoir and selectively delivering the herbicide to unwanted vegetation by direct contact of an applicator containing the herbicide with the unwanted plant or vegetation.

### CROSS REFERENCE TO RELATED APPLICATION

This application is a continuation-in-part application of U.S. application Ser. No. 09/689,459.

### BACKGROUND OF THE INVENTION

1. Field of the Invention

The present invention relates to the field of herbicides, and more particularly to devices and methods for the controlled application of herbicides, and further has application to the controlled delivery of pesticides.

2. Brief Description of the Related Art

Herbicides are frequently and widely used to eliminate unwanted vegetation growth. Herbicidal activity generally is designed to affect the entire plant, and is commonly applied by delivery to the foliage of the unwanted plant. Often herbicides are provided with an active component in a water-based solution, or are provided to be mixed with water for dilution. It is known to apply herbicides by spraying, where the herbicide is delivered through a nozzle. The prior art nozzle-type delivery devices, which are widely used, sometimes include an ability for stream or spray delivery. Usually, a trigger is provided to actuate the delivery of the herbicide through the nozzle. The trigger action draws a flow of the contained herbicide from a tube which extends into a reservoir for delivery through the nozzle. In addition to the spray/stream option for delivery, it has further been known to provide nozzles with an “off” position, which is easily switchable between the delivery positions and the “off” position. However, although it is desirable for the user to readily switch the nozzle between delivery positions and “off” positions, child safety is compromised when a device can be easily operated. While steps can be taken to keep herbicides and other items which may be toxic to humans or animals, in secured or out-of-reach locations, there always exists the possibility that a child or animal will inadvertently gain access to the container of the poisonous substance.

Spraying herbicides has other risks, namely that overspray will hit desirable plants, or drips from a treated plant will fall onto a desirable plant. Further, to this effect, any overspray or drips can leach into the environment, and have the potential to contaminate a water supply. Wind can also blow the herbicide spray stream onto other nearby plants or to other areas. The sprayer also limits the degree of travel of the herbicide, where the trigger lever degree of travel limits the distance of a stream or spray delivered. The trigger spray type mechanism does not provide a child-resistant closure, and must be kept in a place out of the reach of children and pets.

Other types of herbicide delivery devices have included a hockey stick with a tube provided on the blade to deliver herbicide to weeds surrounding plants, which is disclosed in a paper entitled “Hockey Stick Weed Wiper” by Arthur W. Seiders, published by West Virginia University.

A “Herbicide Applicator With Vegetation Grabbing Jaws” is disclosed in U.S. Pat. No. 5,724,765 issued on Mar. 10, 1998, which grabs weeds between absorbent pads and has needles that penetrate into the weed so that the herbicide on the adsorbent pads can coat the surface of the weed and flow into the needle holes.

Another device for ridding weeds is disclosed in U.S. Pat. No. 5,606,822 issued on Mar. 4, 1997, entitled “Plant Cutting Shears With a Chemical Applicator,” which has a chemical holding element on the shears for contacting the plant when it has been cut.

Turning to the concern of safety, herbicides are generally poisonous compounds which require a user to exercise caution in their handling and storing. Tamper resistant, or child-proof containers have been used primarily with pharmaceuticals, which, in some cases, if accidentally ingested by children or pets, can be fatal. An example of a “Child-resistant Locking Means for a Twist-action Container” is disclosed in U.S. Pat. No. 3,989,152 issued to Randall K. Julian on Nov. 2, 1976. Similarly, U.S. Pat. No. 4,572,385 for a “Tamper Indicating Child Resistant Threaded Closure” issued on Feb. 25, 1986 to Edward Luker, discloses a one-piece threaded cap with a non-backoff feature. U.S. Pat. No. 5,379,910, issued on Jan. 10, 1995 to Gary G. Montgomery, discloses an “Apparatus for Sealing a Container and Closure” which utilizes complementary cap and neck threads. However, prior devices for delivering herbicides have their actuators, such as triggers, exposed. Where trigger, and spray head type mechanisms are used, they are for the most part large and therefore, providing an additional accessory for their containment, such as a cover, is impractical and not efficient, where doing so would make the spray apparatus even larger. Retail and stock shelf space, as well as shipping space would need to be increased to handle a larger delivery device if it were placed in a container. Since it is desirable to minimize the amount of space on a shelf which a product takes up, and to minimize the amount of volume needed for shipping space, the prior known herbicide delivery devices generally are not covered. Rather, the spray nozzle or valve remains exposed, even when the apparatus is not in use.

Other devices exist for the application of a fluid, however, these prior art devices each have an exposed portion which remains available for contact even when the device is not in use. For example, U.S. Pat. No. 5,641,233 issued to Thomas E. Wilson on Jun. 24, 1997 for a “Brush Apparatus” provides a brush applicator for use with a container for a fluid product. The brush of the apparatus, however, remains exposed after use. Similarly, U.S. Pat. No. 5,857,796 issued to Douglas G. Waldmond on Jan. 12, 1999 for an “Applicator with Reservoir” likewise, provides an applicator with an exposed member thereon. U.S. Pat. No. 4,424,918 issued to Gene Stull on Jan. 10, 1984 for “Non-Resealable Dispenser Cap Construction” provides a container with a dispensing nozzle to prevent resealing.

A need exists for a herbicide delivery system which has child safety features and which can be used to control the application of the herbicide through select delivery to the unwanted vegetation, while leaving the desirable vegetation unaffected.

### SUMMARY OF THE INVENTION

In accordance with the present invention, a device and method of applying a herbicide to remove unwanted vegetation growth are provided. The device and method are also be useful for the controlled delivery of pesticides. The herbicide and pesticide delivery device in accordance with a preferred embodiment of the invention has a safety cap with a child-proof locking feature, a reservoir for containing a herbicide or pesticide, a valve unit, and an applicator, such as a brush, through which a herbicide or pesticide compound can be delivered to an unwanted plant. The delivery of the compound to the brush is accomplished with a twist valve which is rotated to regulate the amount of herbicide which is to be delivered through the valve unit.

The method according to a preferred embodiment of the invention includes the steps of providing a herbicide or pesticide chemical in a reservoir, and selectively delivering the herbicide or pesticide from the reservoir through an applicator, and directly contacting with the herbicide-carrying applicator the unwanted vegetation, such as a weed, in the case of a herbicide or along a path of insect travel in the case of a pesticide.

It is an object of the present invention to provide a novel herbicide device which can selectively deliver a herbicide to unwanted vegetation while leaving the desired vegetation, such as surrounding vegetation intact.

It is another object of the present invention to provide a novel method for the selective removal of unwanted vegetation, where the unwanted vegetation is directly contacted by an applicator.

It is another object of the present invention to accomplish the above objects, where the herbicide device has security features, which include a child-safety cover.

It is another object of the present invention to provide an improved method for eliminating unwanted vegetation, which has minimal or no side effects on surrounding or underlying plants.

It is a further object of the present invention to accomplish the above objects by providing a method and apparatus which will conserve the volume of herbicide required to accomplish the task to ridding unwanted vegetation or plants.

It is another object of the present invention to reduce the potential for environmental contamination by minimizing the amount of herbicide chemical necessary for ridding unwanted vegetation, and controlling its delivery.

It is a further object of the present invention to provide a novel herbicide device which is compact and space-saving, yet has child-resistant closing features.

It is an object of the present invention to provide a novel pesticide device which can selectively deliver a pesticide along a path of travel where insects cross.

It is another object of the present invention to provide a novel method for the selective control of insects, where the insects are controlled along a boundary through the contact of a path with an applicator.

It is another object of the present invention to accomplish the above objects, where the pesticide delivery device has security features, which include a child-safety cover.

It is another object of the present invention to provide an improved method for delivering a which has minimal spreading to adjacent areas of the path of insect control.

It is a further object of the present invention to accomplish the above objects by providing a method and apparatus which will conserve the volume of pesticide required to accomplish the task to ridding unwanted vegetation or plants.

It is another object of the present invention to reduce the potential for environmental contamination by minimizing the amount of pesticide chemical necessary for controlling insects.

It is a further object of the present invention to provide a novel pesticide device which is compact and space-saving, yet has child-resistant closing features.

### BRIEF DESCRIPTION OF THE DRAWING FIGURES

FIG. 1 is a front elevation view of a device for delivery of herbicides or pesticides constructed according to the present invention, shown angled with the applicator positioned to contact a plant.

FIG. 2 is an enlarged front view of a portion of the device of FIG. 1, shown with the overcap installed, showing the valve unit and overcap in sectional view.

FIG. 3 is a top plan view of the herbicide device of FIG. 2.

FIG. 4 is a sectional view of the overcap of the device shown in FIG. 2, viewed separately from the other components, taken along the line 4-4 of FIG. 3.

FIG. 5 is a perspective view showing the top portion of the herbicide device of FIG. 1.

FIG. 6 is an enlarged, front partial view of the device of FIG. 1, showing the valve unit and reservoir in sectional view, with the twist valve appearing in its raised, fully open position.

FIG. 7 is a cross sectional view of an alternate embodiment of a valve stem constructed in accordance with the present invention.

FIG. 8 is a bottom plan view of the valve stem of FIG. 7.

FIG. 9 is a top plan view of an alternate embodiment of a reservoir according to the present invention shown configured for use with the alternate valve stem embodiment of FIGS. 7 and 8.

FIG. 10 is an enlarged, partial view of an alternate embodiment of a herbicide device constructed in accordance with the present invention, showing the top portion of the container, the valve unit and overcap in sectional view.

FIG. 11 is a front elevation view of the device of FIG. 10, shown with the overcap removed with the valve unit and container in exploded view.

FIG. 12 is a front elevation view of the top portion of the container, and valve unit shown with the overcap in place.

FIG. 13 is a top plan, separate view of the container shown in FIG. 10 with the overcap removed.

FIG. 14 is a front sectional view of an alternate embodiment of a valve unit constructed in accordance with the present invention, showing the valve unit in an open position.

FIG. 15 is a front sectional view of an alternate embodiment of a valve unit constructed in accordance with the present invention, showing the valve unit in its closed position.

FIG. 16 is a front sectional view of an alternate embodiment of a device for delivery of herbicides and pesticides constructed in accordance with the present invention, showing an alternate embodiment of the connecting means of the valve unit and reservoir.

FIG. 17 is a bottom plan view taken along the line 17-17 of FIG. 16 showing the valve unit separate from the reservoir.

FIG. 18a is a front sectional view of an alternate embodiment of a valve unit constructed in accordance with the present invention, shown in an open position.

FIG. 18b is a front sectional view of an alternate embodiment of a valve unit constructed in accordance with the present invention, shown in a closed position.

FIG. 19 is a sectional view taken along the line 19-19 of FIG. 18a, showing the valve stem in separate view.

FIG. 20 is a sectional view of the valve stem taken along the line 20-20 of FIG. 19.

FIG. 21 is a front sectional view of an alternate embodiment of a valve unit showing a valve stem having threads.

FIG. 22 is a front sectional view of an alternate embodiment of a cover element of a valve unit constructed in accordance with the present invention, shown separate from the valve stem.

### DETAILED DESCRIPTION OF THE PREFERRED EMBODIMENTS

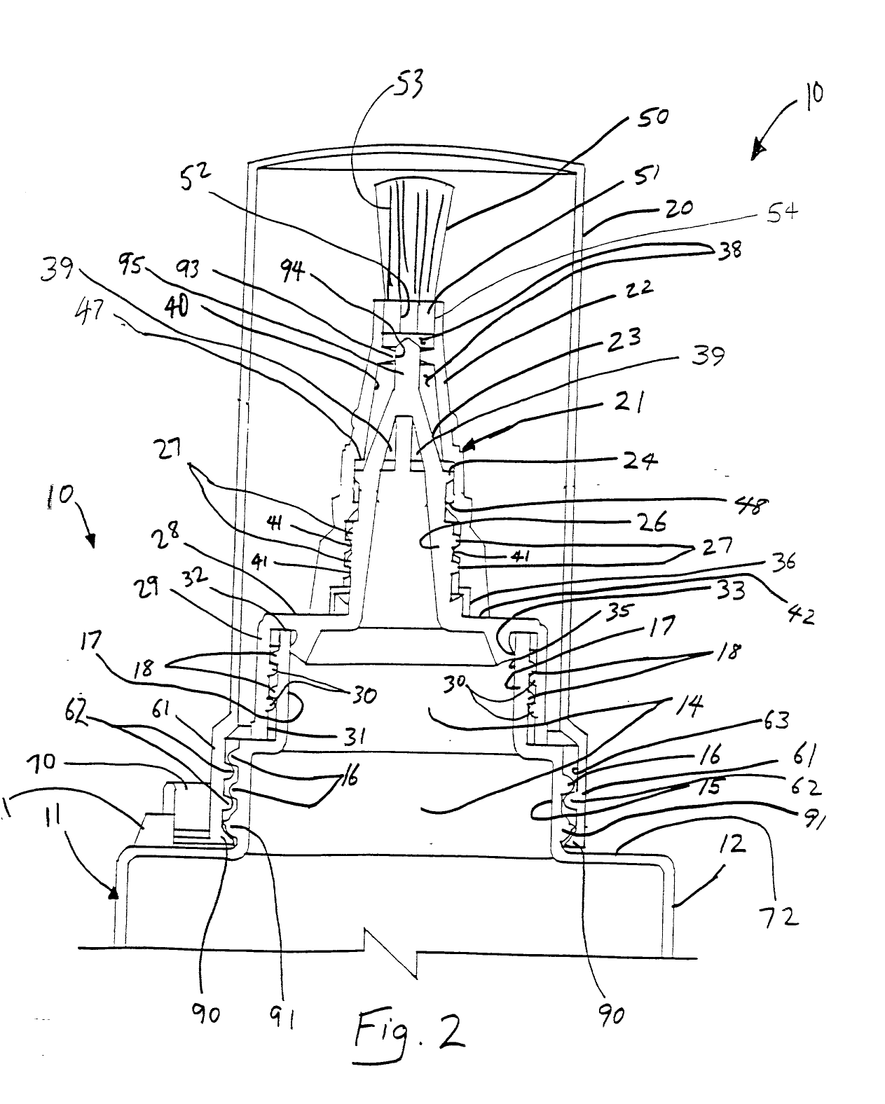

Referring to the drawings, a herbicide and pesticide device 10 constructed according to the present invention is shown. The device will be described herein in connection with herbicide delivery. It will be understood that the device can utilize a pesticide chemical to control pests, such as insects, by placing a pesticide in the reservoir. In a preferred embodiment of the invention, the device for delivery of herbicides 10 comprises reservoir means for containing a herbicide compound and delivery means for delivering the herbicide compound from the reservoir means to the unwanted vegetation. The reservoir means is shown comprising a reservoir 11 having a cylindrical body wall 12, a bottom 13 and a neck 14. The device 10 further comprises cover means for safely securing the herbicide contained in the device 10. In accordance with a preferred embodiment of the invention, as shown best in FIG. 2, the cover means comprises an overcap 20 which is removably installed on the neck 14 of the reservoir 11 to cover the delivery means. A first connection means is provided for connecting the overcap 20 to the reservoir 11. The first connection means is shown preferably comprising a first threaded portion 15 having threads 16 thereon provided on the neck 14 of the reservoir 11. Second connection means is provided for connecting the delivery means to the reservoir 11. The second connection means preferably comprises a second threaded portion 17 with threads 18 disposed on the neck 14. Preferably the first threaded portion 15 and second threaded portion 17 of the neck 14 are cylindrical in configuration, and the threads 16, 18, respectively, are annularly disposed thereabout.

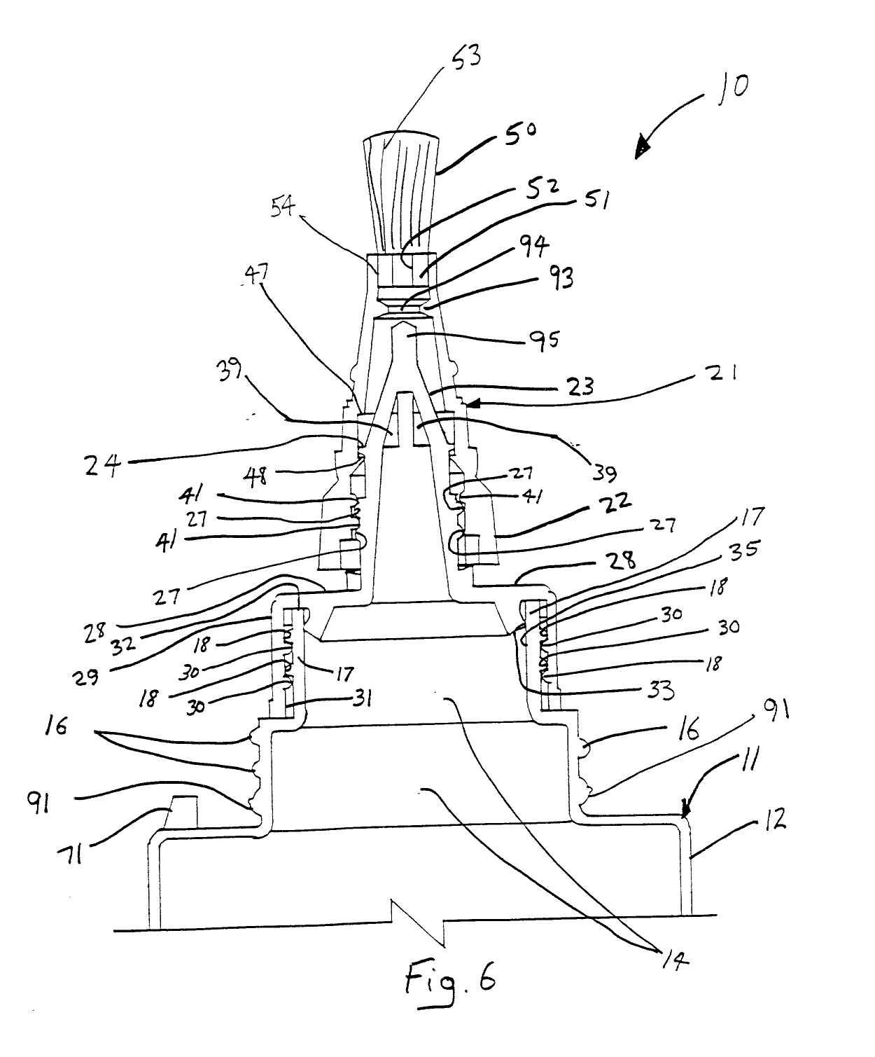

The delivery means regulates the flow of the herbicide compound released from the reservoir 11. The delivery means preferably comprises means for sealingly containing the herbicide compound within the reservoir 11. In a preferred embodiment of the present invention, as shown best in FIG. 2 and 6, the delivery means comprises a valve unit 21 having a twist valve 22 and a valve stem 23 with passage means to allow herbicide to flow therethrough. Preferably, the passage means of the valve stem 23 comprises a plurality of openings 39 formed therein for facilitating even distribution of a herbicide compound through the valve unit 21. The valve stem 23 has seal means which seals the twist valve 22 and valve stem 23 to eliminate or reduce the potential for leakage between the valve components. The seal means preferably comprises a closing flange 24 which is annularly disposed on the valve stem 23. The valve stem 23 further has a threaded portion 26 with threads 27 disposed thereon. Connection means is provided for connecting the valve stem 23 to the reservoir 11. Preferably, the connection means comprises a shoulder 28 provided at the base of the valve stem 23, and a cylindrical portion 29 extending from the shoulder 28. The cylindrical portion 29 has an inner circumferential wall 31 with matingly associated threads 30 disposed thereon. The matingly associated threads 30 are provided to secure the valve unit 21 to the second threaded portion 17 of the reservoir neck 14 by engaging the threads 18.

Gasketing means is provided for sealing the valve stem 23 with the rim 32 of the reservoir 11 to prevent leakage of the herbicide. The gasketing means is shown comprising a gasket flange 33 disposed on the valve stem 23 and positioned in the neck 14 of the reservoir 11, below the rim 32 and above the valve stem shoulder 28. The gasket flange 33 engages the inner surface 35 of the reservoir neck 14 to minimize or prevent leakage of herbicide from the reservoir 11. While not shown, it will be understood that the gasketing means, alternately or in addition to, can comprise a screen or other filter through which the herbicide may pass, but where solids, dirt, debris or other contaminants which may be present in the reservoir 11 are screened out and not allowed to enter the valve unit 21.

The valve unit 21 can be operated to control the flow of herbicide delivered to the applicator means, such as the brush 50. The twist valve 22, in a preferred embodiment of the invention shown in the figures, has an interior space 38 defined by an inner wall 40. The inner wall 40 has matingly associated threads 41 disposed thereon for engagement with the threads 27 of the valve stem 23. The valve stem threads 27 and matingly associated twist valve threads 41 are permit the twist valve 22 to be rotated relative to the valve stem 23 to regulate the amount of the flow of herbicide which is to be delivered from the reservoir 11 through the valve unit 21. An annular groove 36 is disposed in the inner surface 40 of the twist valve 22, at the end of the twist valve 22 nearest the valve stem shoulder 28. The twist valve 22 has a rim 42 which is configured to close against the shoulder 27 of the valve stem 23.

The valve closure means, as best shown in FIGS. 2 and 6, comprises a first locking rim 47 and a second locking rim 48 disposed on the inner surface 40 of the twist valve 22. The closing flange 24 of the valve stem undergoes vertical movement in relation to the reservoir 11 when the twist valve 22 is rotated. The closing flange 24 of the valve stem 23 engages the first locking rim 47, when the valve unit 21 is in the fully open position. Similarly, the closing flange 24 engages the second locking rim 48 when the twist valve 22 is rotated to its fully closed position (FIG. 2.) To form a barrier for blocking a back flow of herbicide from leaking through the valve unit 21.

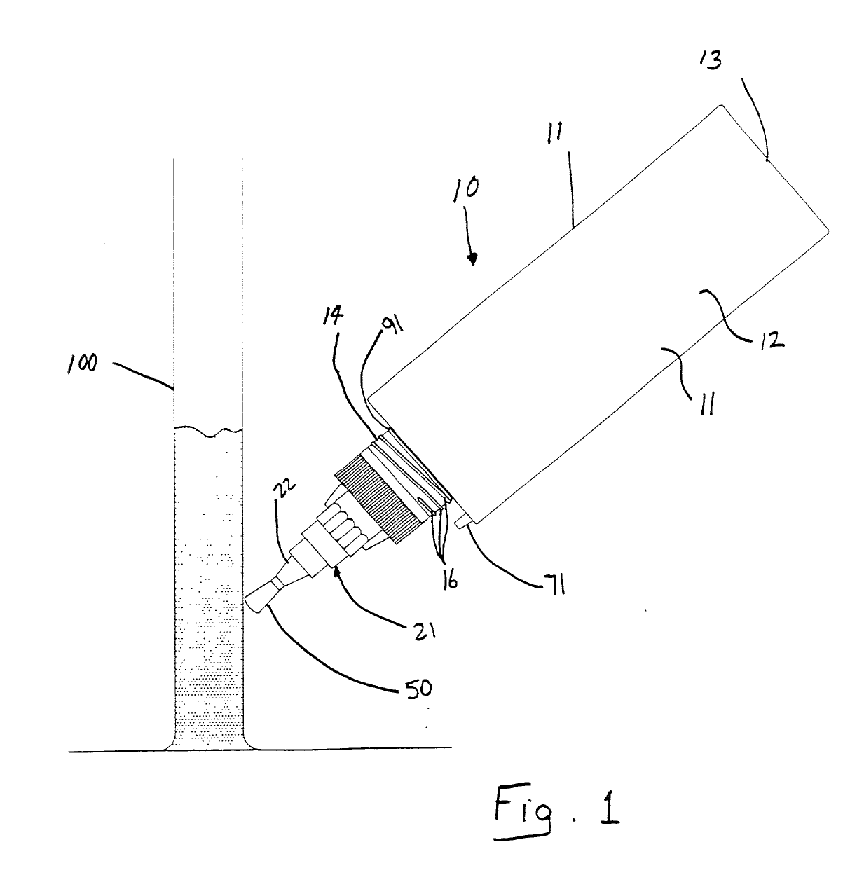

In accordance with a preferred embodiment of the invention, the containment of the herbicide is further facilitated with a flow-blocking flange 93 which is disposed on the inner surface 40 of the twist valve 22. The flow-blocking flange 93 has an aperture 94 disposed therein through which the tip 95 of the valve stem 23 may pass. As shown in FIG. 1, the twist valve 22 is in the closed position with the tip 95 being extended through the aperture 94 of the blocking flange 93.

Referring to FIG. 6, the twist valve 22 is shown raised off of the valve stem shoulder 28. The twist valve 22 is in the open position and the valve stem tip 95 positioned below the flow-blocking flange 93. The herbicide flow channel from the reservoir 11, through the valve stem openings 39, and through the twist valve flow-blocking flange aperture 94, is opened to permit a flow of herbicide onto the applicator or brush 50.

The device 10 has applicator means for directly applying a herbicide compound to undesirable vegetation. The applicator means, as shown in a preferred embodiment of the invention, comprises a brush 50 provided at an end of the valve unit 21. The brush 50 preferably has a support 51 comprising a cylindrical ring member configured to fit in the end of the twist valve 22 and having a channel 52 extending there through and communicating with the interior space 38 between the twist valve 22 and valve stem 23. The channel 52 communicates with the bristles of the brush 50 and the brush 50 absorbs the herbicide on its bristles 53.

Safety cover means is provided for selectively covering the twist valve 22 and brush 50. In a preferred embodiment of the invention, the safety cover means comprises an overcap 20 having a connecting portion 61 with connecting means for connecting to the first threaded portion 15 of the neck 14 of the reservoir 11. The connecting portion 61 has in an inner surface 63. The connecting means preferably comprises matingly associated threads 62 disposed on the inner surface 63 for removably securing the overcap 20 onto the reservoir 11. Locking means is provided for locking the overcap 20 onto the reservoir 11. The locking means comprises a depressable tab 70 disposed on the connecting portion 61 of the overcap 20. The locking means further comprises an associated tab stop means for stopping the tab 70. The tab stop means is shown preferably comprising an abutment stop element 71 disposed on the shoulder portion 72 of the reservoir 11.

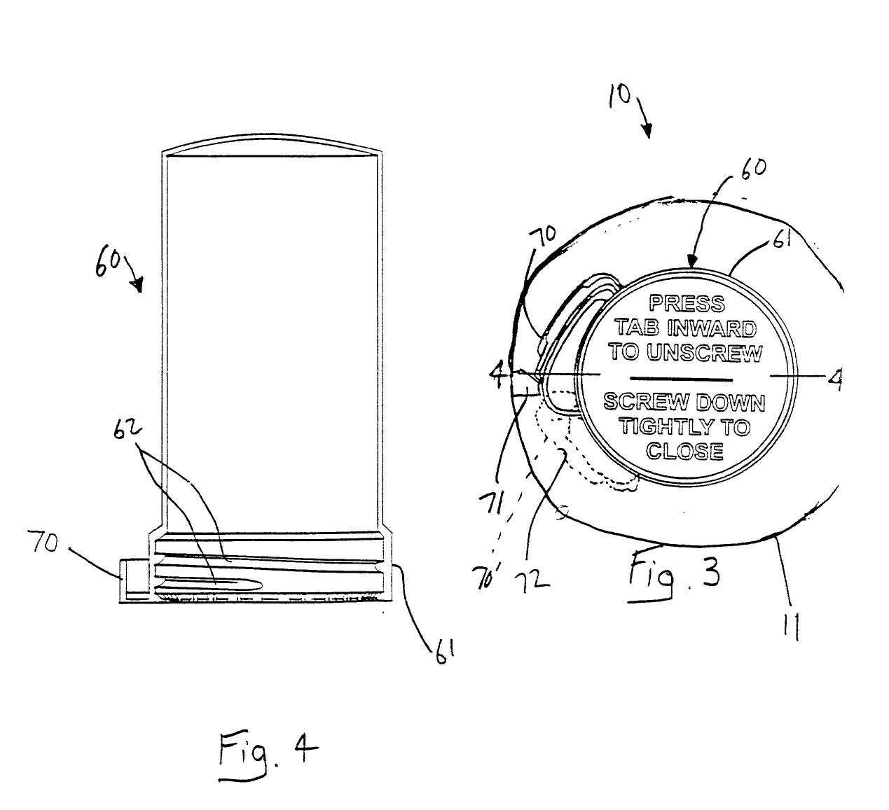

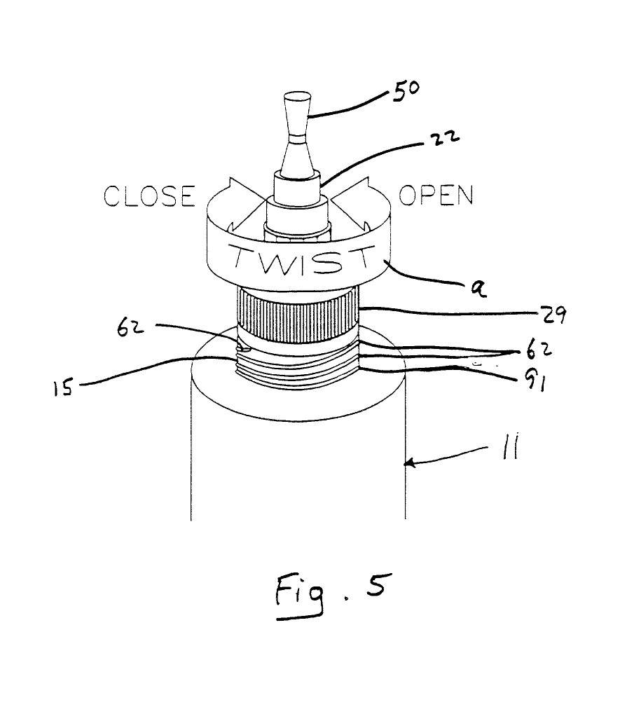

Referring to FIGS. 2 and 3, the overcap 20 is secured to the reservoir 11 through connection of its threads 62 with the threads 16 of the first neck portion 15, by rotating the overcap 20 to tighten it on the reservoir 11, so that the tab 70 is depressed to pass the abutment stop element 71. When the tab 70 clears the abutment stop element 71, the overcap 20 is secured to the reservoir 11 in its closed position, represented by the tab 70 shown in broken lines. In this position, the abutment stop 71 prevents loosening of the overcap 20 without a determined effort and application of force in order to depress the tab 70 while rotating the overcap 20. To release the overcap 20, the tab 70 is depressed inwardly, toward the overcap 20 and the overcap 20 rotated so that the tab 70 passes beyond the tab abutment stop 71. Once the tab 70 clears the stop 71, the overcap 20 can be rotated further, so that it may be removed from the device 10.

The safety cover means can further have securing means for releasably securing the overcap 20 to the reservoir 11. The securing means facilitate the holding of the overcap 20 on the reservoir, and provide yet additional holding force, which must be overcome in order to release the overcap 20. The securing means preferably comprises annular lugs 90 disposed circumferentially about the edge of the connecting portion 61 to secure the overcap 20 to the reservoir 11 by engagement with an annular lug ring 91 which is disposed around the neck 14 near the shoulder 72 of the reservoir 11.

Referring now to FIG. 5, after the overcap has been removed from the reservoir 11, the herbicide device 10 may be operated to deliver herbicide to unwanted vegetation. To operate the device 10, the twist valve 22 which carries the applicator brush 50 thereon, is rotated in a counterclockwise direction, as shown by arrow “a”. Referring to FIG. 6, it is shown that the rotation of the twist valve 22 elevates the flow-blocking flange 93 to open the flow channel from the valve space 38 through the flow-blocking flange aperture 94. The herbicide then passes through the end of the twist valve 22, and onto the brush 50.

Once the twist valve 22 has been rotated from its closed (FIG. 2) position to a position where the stem tip 95 is partly or fully out of engagement with the flow-blocking flange 93 (such as the position shown in FIG. 6), the herbicide device 10 is then preferably tilted at an angle relative to the ground so that a quantity of the herbicide compound is permitted to flow from the reservoir 11, through the valve unit 21, and onto the brush 50. The brush 50 is placed in direct contact with the surface of a plant 100 for treatment with the herbicide. In order to increase the delivery flow from the device 10, the reservoir 11 is preferably constructed of a flexible material, such as a plastic, which can be compressed by a user's hand to increase the flow of the herbicide through the valve unit 21 and onto the brush 50. This can be done by gravity, or by a user applying a gentle pressure on the exterior of the reservoir 1, or a combination of both. Furthermore, the flow may be controlled by the positioning of the twist valve 22, relative to the valve stem 23. The further the rotation of the twist valve 22 in the counterclockwise direction of double arrow “a” (FIG. 5) the greater the flow of the herbicide, as the tip 95 of the valve stem 23 is lowered from the flow-blocking flange 93. The flow can be regulated by the positioning of the valve stem tip 95 relative to the flow-blocking flange 93, in a range or relative positions from fully closed (FIG. 2) to fully open (FIG. 6).

After using the herbicide device 10, it is returned to an upright position and the twist valve 22 is rotated clockwise in the direction of double arrow “a” (FIG. 5) into its closed position (FIG. 2). The closing of the twist valve 22 by rotating it clockwise positions the tip 95 of the valve stem 23 in the aperture 94 of the flow-blocking flange 93 to block flow onto the brush 50. The child resistant overcap 20 is then installed on the reservoir 11 to cover the valve unit 21. The installation of the overcap 20 is done by connecting the connecting means, such as in the preferred embodiment, screwing the overcap 20 onto the reservoir 11, the until the annular lugs 90 of the overcap 20 engage the annular lug ring 91 of the reservoir neck 14, and the depressable tab 70 passes the tab abutment stop 71.

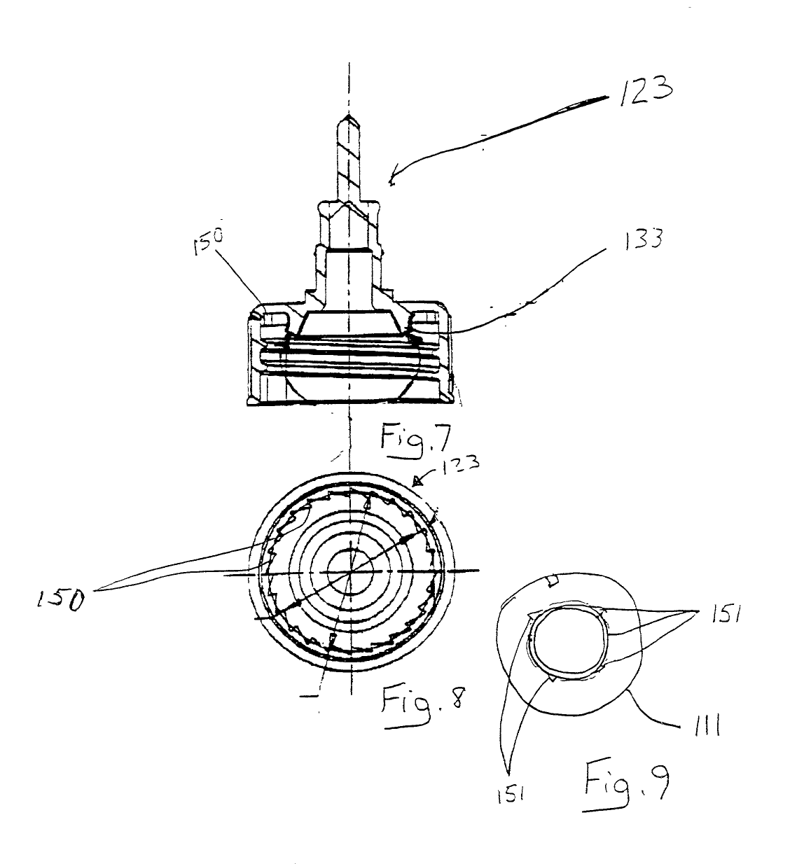

Referring now to FIGS. 7-9, an alternate embodiment of a reservoir 111 and valve stem 123 is shown. The valve stem 123 preferably is constructed with a one-way connection means, so that removal of the valve stem 123 is irreversible, and not possible, once the valve stem 133 has been attached to a container, such as the reservoir 111. As shown in FIG. 8, ratchet means is provided for maintaining a one-way irreversible connection between the valve stem 123 and reservoir 111. The ratchet means in a preferred embodiment comprises ratchet teeth 150 disposed on the valve stem 123. The reservoir 111 is provided with a plurality of matingly associated teeth 151 which engage with the ratchet teeth 150 of the valve stem 123. Once engagement between the matingly associated valve stem ratchet teeth 150 and reservoir teeth 151 occur, the valve stem 123 can not be removed from the reservoir 111. This provides an added safety measure to guard against accidental access to the contents of the reservoir 111. The valve stem 123 and reservoir 111 can be provided for use with the other components, such as the overcap 60, twist valve 22, and other elements described above, to deliver herbicide to an unwanted plant.

While the applicator means is shown in a preferred embodiment of the invention comprising a brush 50 with a flow-through channel 52 associated therewith, it will be understood that other applicators which permit fluid flow therethrough consistent with the principles of the present invention, can be used, such as, for example, pads, sponges and the like. Further, the application means can comprise an aperture, such as the aperture 54 provided at the end of the twist valve 22, as shown in FIGS. 2 and 6. The aperture 54 permits an increased flow amount, such as, for example when treating a large plant, or rougher vines and shrubs.

In accordance with a preferred embodiment of the present invention, a preferred herbicide compound can comprise an oil-based or water-based compound which has flowable properties, and is able to be dispensed by flowing through the valve unit 21 and associated flow through brush 50. In one preferred embodiment of the invention, an oil based herbicide compound is used, and is applied to the trunk or stem of plant, such as a weed, growth or other vegetation, for direct absorption through the plant's outer surface. The direct application and oil base facilitates maximum activity with the unwanted vegetation to aid in its removal. The oil based herbicide compound can be absorbed through the cambium and enter the phloem to maximize or enhance the herbicidal activity on the plant. Preferably, the herbicide suitable for use with the present invention is a compound comprising the active ingredient of a triclopyr butoxyethyl ester, which is provided as an oil based composition. Alternately, or in addition to the herbicide of the preferred embodiments, other herbicides having similar properties may also be used in accordance with the present invention. For example, the following herbicides, which are of the penetrating type may be utilized and delivered to an unwanted plant in accordance with the present invention: Garlon-4 (Dow Agro Sciences); Pathfinder II (Dow Agro Sciences); Pathway (Dow Agro Sciences); Stalker (American Cyanamid); BK800 (PBI Gordon); and Tree Hold (Amvac). Preferably, the herbicide is formulated in an oil-base fluid and can be suspended in the fluid or mixed therewith for dispensing through the valve unit 21 of the herbicide device 10.

The herbicide compound sold as PATHFINDER II was stored in the container and delivered to the stems of unwanted vegetation with the device of the present invention. After application to the plant stem by the herbicide, the plant was killed within a few days. Plants utilized in the testing were vines and weeds, including thick vines having bark, which was penetrated by the herbicide which was applied with the device of the present invention.

The herbicide was applied by the brush applicator 50 from the reservoir 11 through a valve unit 21. The brush absorbed a quantity of the herbicide formulation and delivered it to the stem of a plant. The plant subsequently died as a result of the direct contact with the herbicide formulation. Once the weeds and vines had been treated using the herbicide device of the present invention, the overcap 20 was installed to safely store the device and its contents.

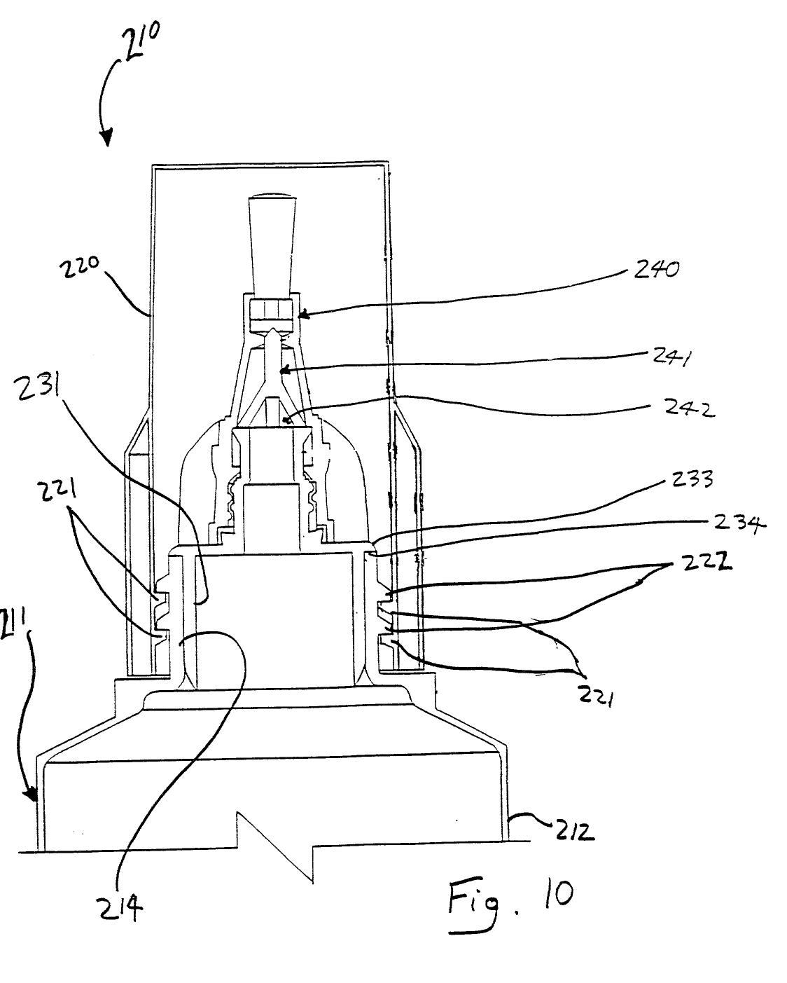

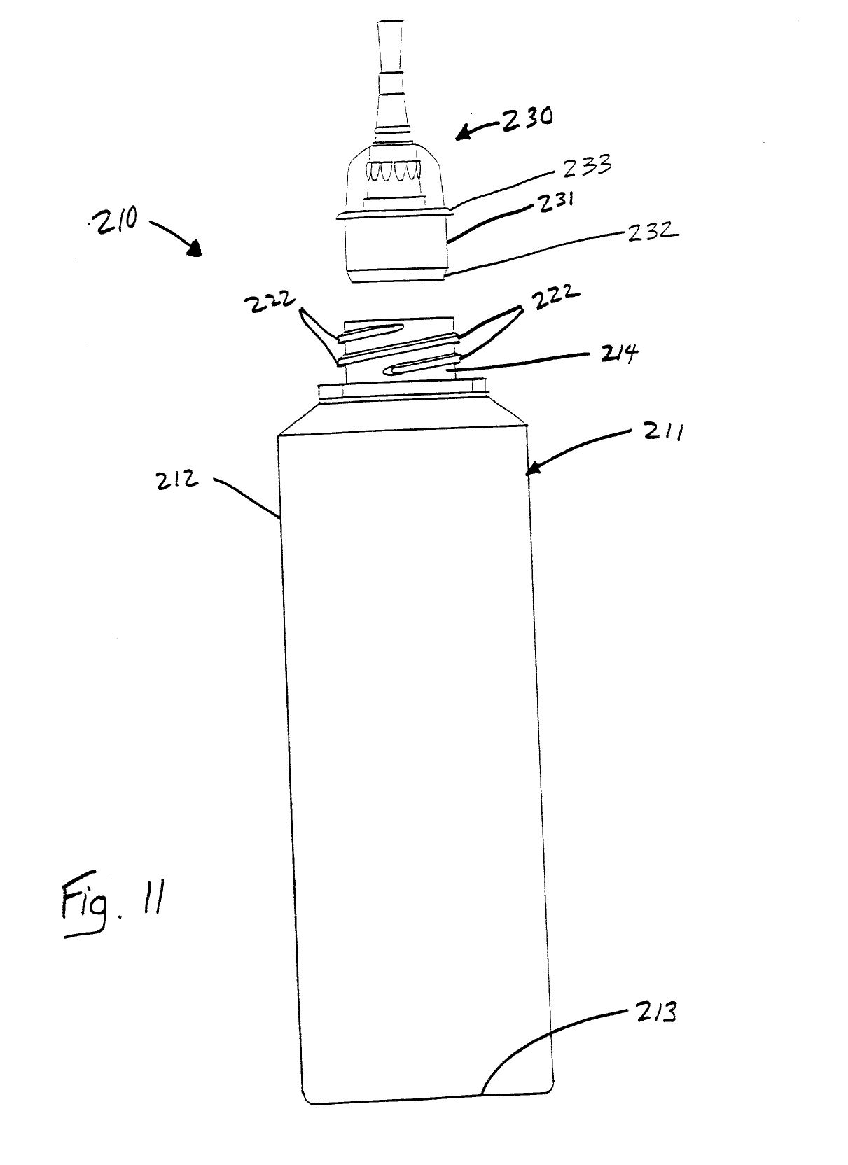

Referring now to FIG. 10, yet another alternate embodiment of a herbicide device 210 according to the present invention is shown, having a reservoir means for containing a herbicide compound therein, and delivery means for delivering the herbicide compound from the reservoir means to the unwanted vegetation. The reservoir means is shown comprising a reservoir 211 shown having a cylindrical body wall 212, a bottom 213 (FIG. 11) and a neck 214. Safety cover means is shown comprising an overcap 220 which is removably installed on the neck 214 of the container 211. The overcap 220 has connection means for connecting it to the container neck 214. Preferably, the connection means comprises threads 221 disposed on the overcap 220. Matingly associated threads 222 are provided on the neck 214 of the container 211.

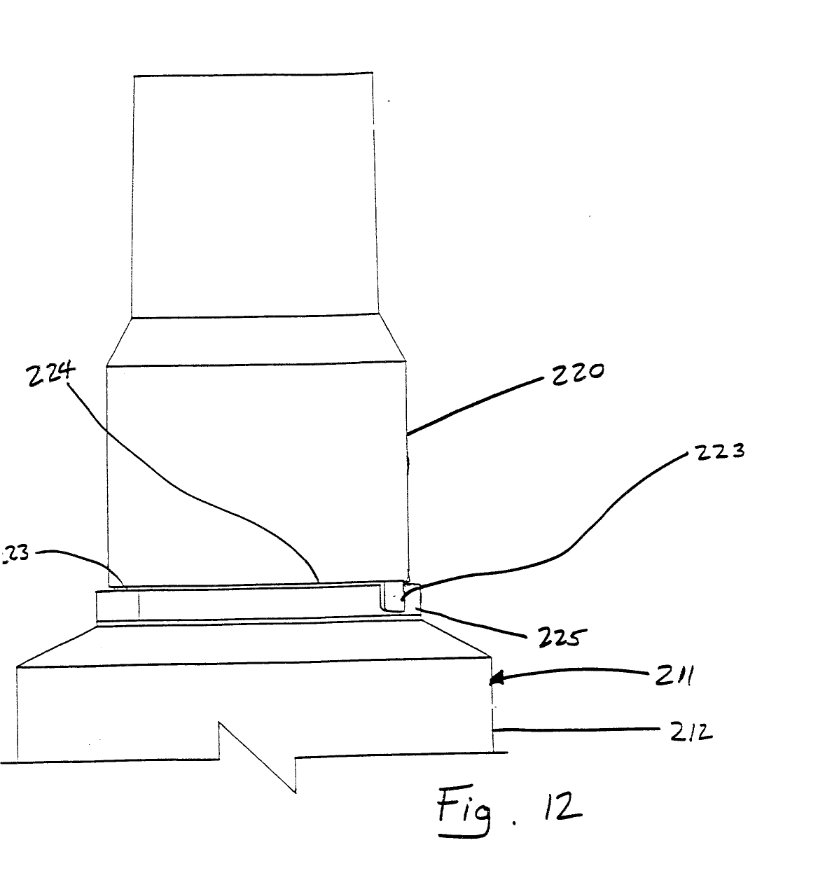

Referring now to FIG. 12, the overcap 220 is shown with the securing means for further securing the overcap 220 onto the container 211. The securing means comprises one or more interfering elements 223 which are disposed on the rim 224 of the overcap 220. Preferably, the rim area of the overcap 220 is flexible so that it can be ovalized out of its configuration with the application of force. The force applied to ovalize the overcap 220 releases the interfering elements 223 from engagement with a corresponding lug 225 on the container 211, and the overcap 220 can then be rotated to unscrew the threads 221, 222 from engagement with each other to release the overcap 220 from the container 211. The force which is required to be applied for ovalizing is generally that which a child cannot exert, and thus the overcap 220 provides an additional obstacle for children to prevent their access to the contents of the container 220.

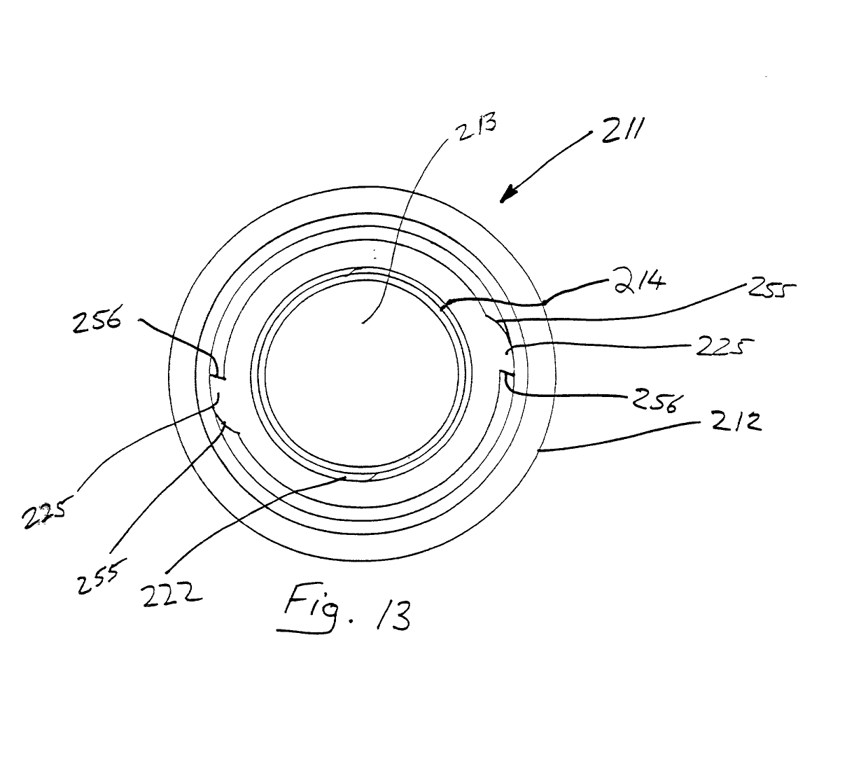

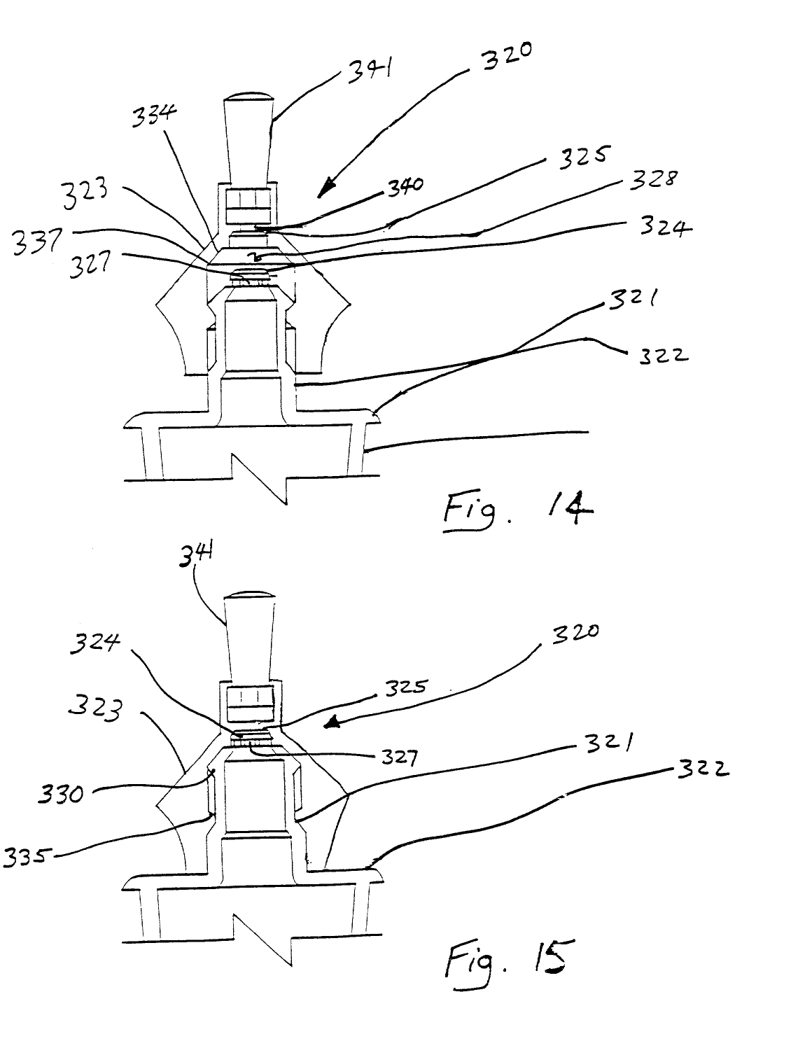

As shown in the top plan view of the container 211 in FIG. 13, the lugs 225 of the container 211 are shown. The lugs 225 are shown having a tapered portion 255 to facilitate the movement of the interfering elements 223 past the lugs 225 to lock the overcap 220 onto the container 211. A locking ridge 256 provides a retaining function to retain the interfering elements 223 of the overcap 220.

Referring again to FIGS. 10 and 11, the delivery means for delivering the herbicide from the container 211 to unwanted vegetation is shown comprising a twist valve unit 230. The twist valve unit 230 preferably has a generally cylindrically configured flange portion 231 with a chamferred edge portion 232, and an upper flange 233 for disposition on the rim 234 of the container (FIG. 10). The twist valve unit 230 further has a twist valve 240 and a valve stem 241 with passage means to permit herbicide to pass therethrough. The passage means preferably comprises a plurality of openings 242 in the valve stem 241. The valve stem 241 extends from the upper flange 233. The valve unit 230, functions similar to the valve unit 21, described above. The alternate embodiment of the herbicide device 210 shown and described in FIGS. 10-12, provides an alternate overcap 220 and the valve unit fits into the neck 214 of the container 211, and is maintained there through a friction fit.

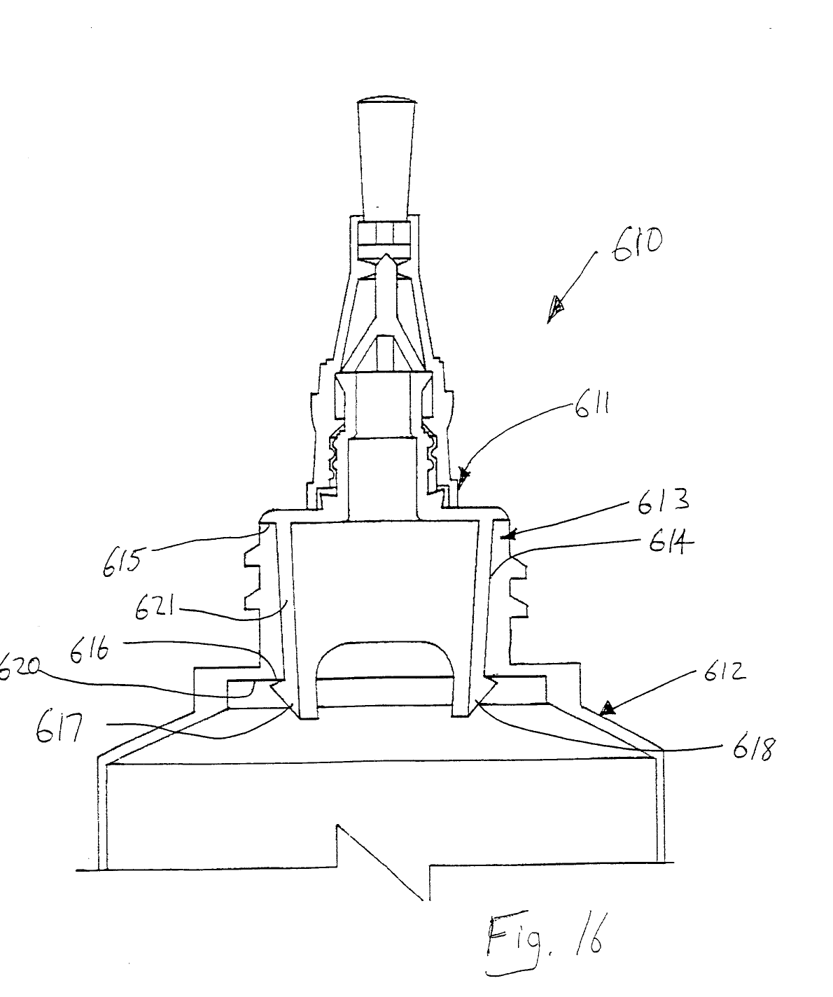

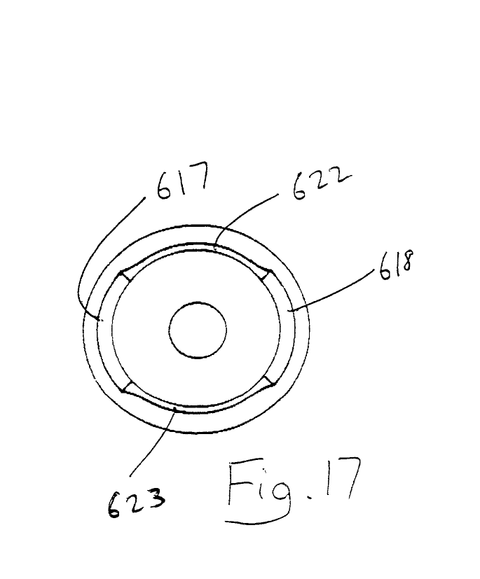

Reference now being made to FIGS. 14 and 15, another alternate embodiment of a valve unit 320 for use in accordance with the herbicide device of the present invention is shown. The valve unit 320 is provided with a stem 321 which is connected to the base or rim 322. A cover element 323 is provided and is slidably installed on the valve stem 321 for movement between a closed position (FIG. 15), where the tip of the valve stem 321 engages the recess 325 of the cover element 323 to block flow of the herbicide from the container (not shown) to which the valve unit 320 is attached, and an open position (FIG. 14) where the tip 324 of the valve stem 321 is not engaging with the recess 325. In the open position (FIG. 14), the herbicide can flow from the container, which can be any of the containers described herein, through the valve stem passage means, shown comprising apertures 327 and into the inner space 328 defined by the cover element 323 and the valve stem 321. An annular stop flange 330 is provided disposed about the valve stem 321 to limit the movement of the valve cover 323 relative to the valve stem 321. The valve cover element 323 has a first stop 334 and a second stop 335 which are spaced apart to provide a range over which the cover 323 can be moved relative to the stem 321. The stop flange 330 is disposed to selectively engage the first stop 334 and second stop 335. A locking flange 337 preferably is also provided to lock the cover element 323 into a locking position on the stem 321 so as to require an amount of force to unlock the cover 323 to lift it from the closed to the open position.

The valve cover 323 has a valve aperture 340 through which the herbicide can be delivered to the applicator, such as for example, the brush 341. The alternate valve unit 320 can be used on a container such as that 211 discussed and shown above. Furthermore, the overcap 220, can be used with the container and the valve unit 320 to further limit access to the herbicide by children.

It will be understood that the overcap 220 can be used to cover the valve units described herein.

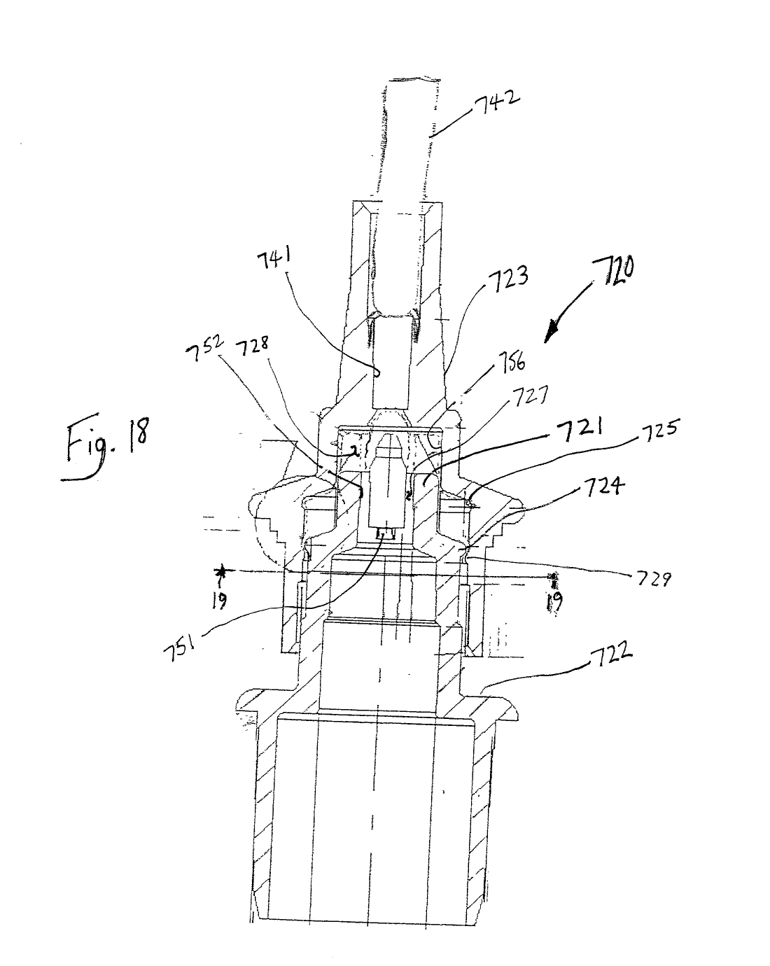

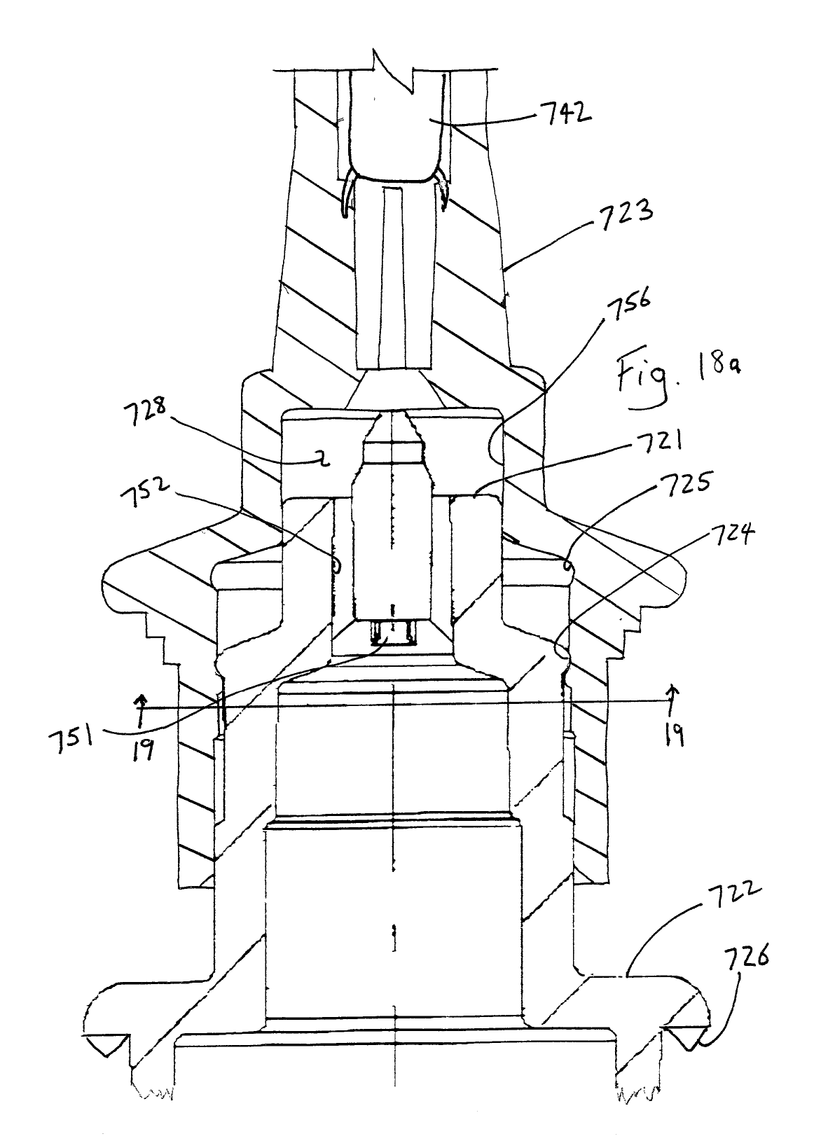

Referring to FIGS. 16 and 17, an alternate embodiment of a device for delivery of herbicides and pesticides 610 constructed in accordance with the present invention is shown. Connecting means is provided for connecting the valve unit 611 with the reservoir 612. The reservoir 612 is shown comprising a container having a neck 613. The reservoir 612 and valve unit 611 can be constructed the same as the reservoirs containers and valve units described above, however, the reservoir neck 613 preferably is provided with a tapered inner circumferential wall 614 which narrows in diameter from the top of the neck 615 to the bottom of the neck 616. Alternately, while not shown, the wall 614 can be non-tapered. Furthermore, the valve unit 611 is provided with a plurality of snap lugs 617, 618 which are disposed for engagement with the lower portion of the neck 616 which terminates and forms a ridge 620. The ridge 620 can comprise a suitable edge with which the snap lugs can engage to secure the valve unit 611 in place on the reservoir 612. The snap-lug features permit one way installation and make removal of the valve unit 611 from the container 612 difficult. Preferably, the snap lugs 617, 618, as shown in FIG. 17, are provided on opposite sides of the valve unit connecting flange 621. In order to facilitate springing of the snap lugs 617 and 618 into position for engagement with the neck 616 and ridge 620, a portion of the circumferential wall 614 is formed having cutouts 622, 623 therein.

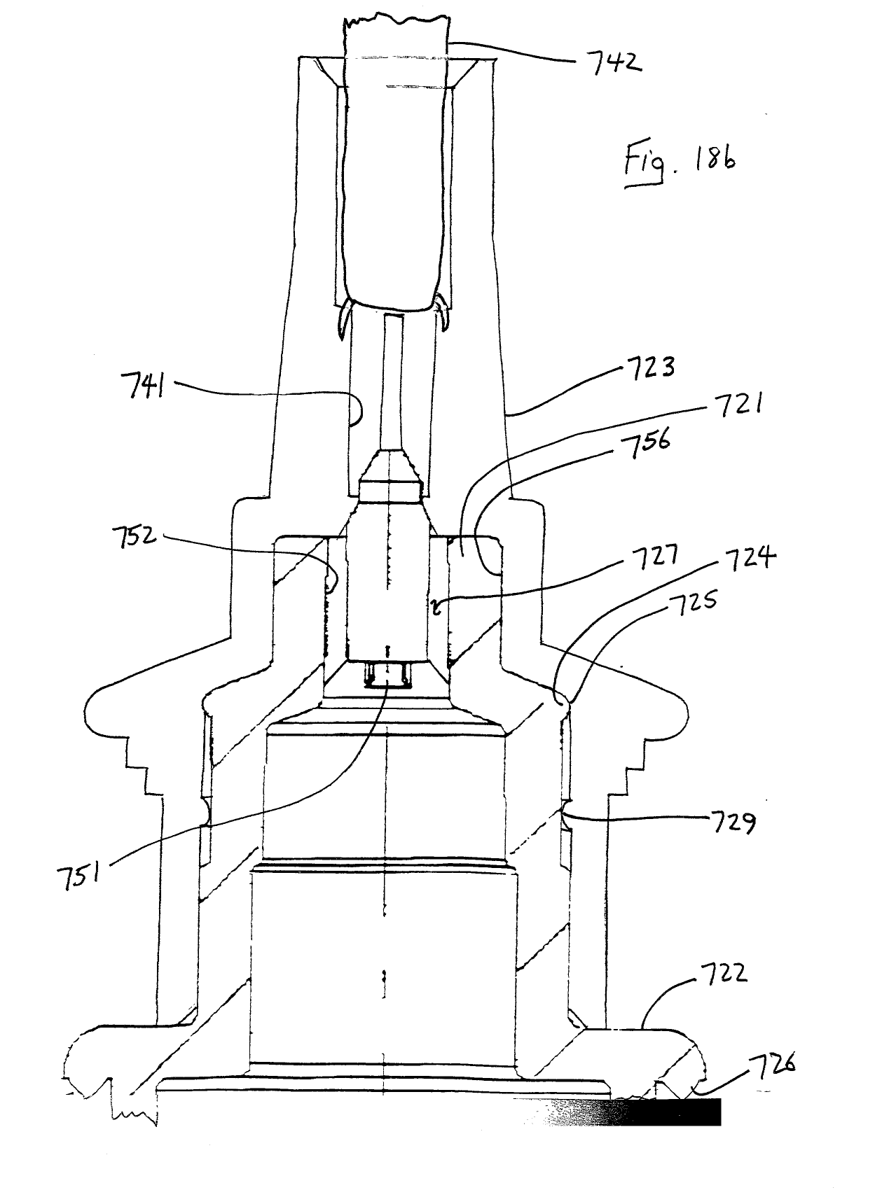

Reference now being made to FIGS. 18-20, another alternate embodiment of a valve unit 720 for use in accordance with the herbicide device of the present invention is shown. The valve unit 720 is provided with a valve stem 721 which has a rim 722, and a circumferential wall 719. The valve unit 720 preferably is mounted on a reservoir by sealingly connecting the circumferential wall 719 with the neck of a reservoir. Preferably the wall 719 is attached to the reservoir by inserting it into the reservoir neck, and securing it thereto with glue or other suitable adhesive.

Alternately, in accordance with another preferred construction, the valve unit 720 may be secured to a reservoir with an annular energy bead 726. The annular energy bead 726 is provided to facilitate attachment to a reservoir, and is shown running the entire circumference of the rim 722. The bead 726 facilitates attachment of the valve unit 720 by fusing to the rim of a reservoir when, for example, the bead 726 is melted by sonic waves.

A cover element 723 is provided and is installed on the valve stem 721 for sliding movement between a closed position, where a locking flange 724 of the valve stem 721 engages an annular upper recess 725 of the cover element 723 to configure the valve unit 720 to block herbicide flow from the container (not shown) to which the valve unit 720 is attached, and a fully open position, where the locking flange 724 of the valve stem 721 engages the annular ridge 729. In the open position, the herbicide can flow from the container, which can be any suitable container, such as, for example, the containers described herein, and through the valve unit 720 stem passage means. Flow moves from the container and through the valve into the inner space 728 defined by the cover element 723 and the valve stem 721. The locking flange 724 and annular upper recess 725 of the cover element 723 preferably secure the cover element 723 into a locking position (shown in phantom) on the stem 721 so as to require an amount of force to unlock the cover element 723 to lift it from the closed to the open position (full-line position).

The valve cover element 723 has a valve aperture 741 through which the herbicide can be delivered to an applicator, such as for example, the brush 742.

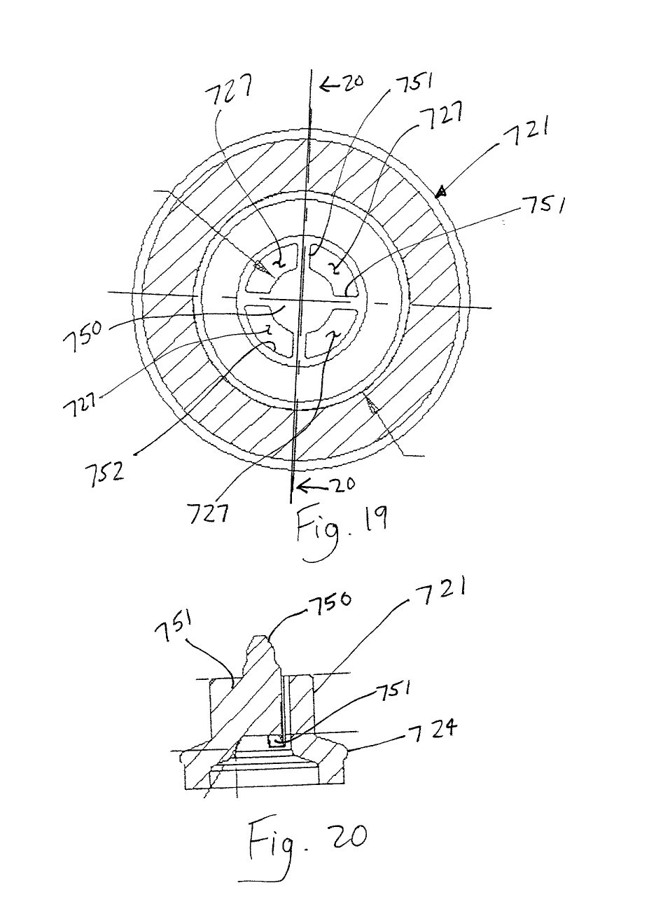

The annular ridge 729 provided on the cover element 723 retains the locking flange 724 to secure the cover element 723 on the valve stem 721. Referring to FIGS. 19 and 20, the valve stem 721 has a tip 750 which is held on the valve stem 721 by connecting fins 751.

The valve unit 720 preferably has channel means for minimizing back flow leakage. The channel means is shown comprising a surrounding wall 752 which is disposed about the stem tip 750. The cover element 723 has an annular inner wall 756. The valve stem 721 is provided with a surrounding wall 752. The surrounding wall 752 engages the inner wall 756 of the cover element 723 to define, in part, the chamber space 728 when the valve unit 720 is in the open position.

The alternate valve unit 720 can be used on a container such as that 211 discussed and shown above. Furthermore, the overcap 220, can be used with the container and the valve unit 720 to further limit access to the herbicide by children.

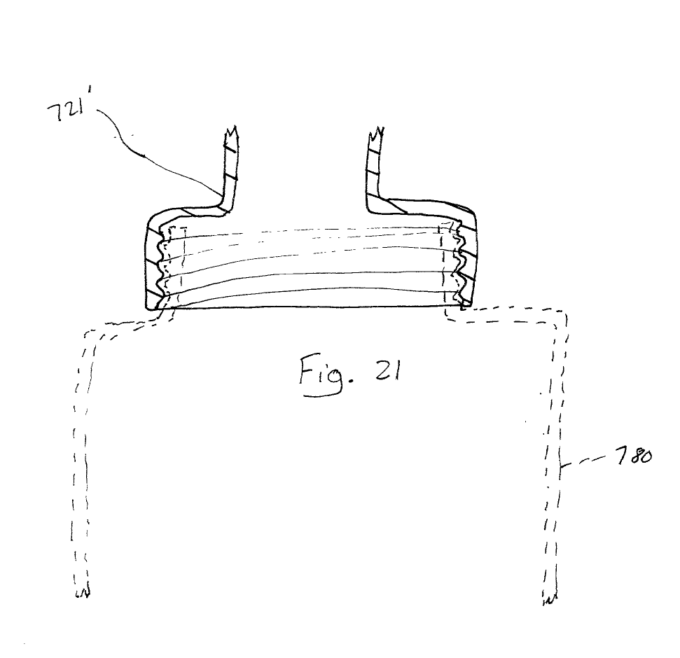

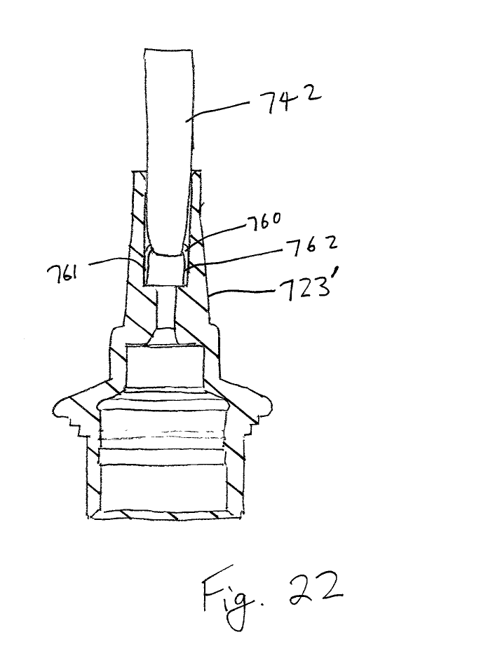

FIG. 21 shows an alternate embodiment of a valve unit 721′ which, is the same as the valve unit 721 shown and described in connection with FIGS. 18-20, except that threads are provided for connecting the valve unit 721′ to a threaded reservoir 780.

In accordance with the invention, a preferred configuration for attaching the applicator means, such as, for example, the brush 742, is shown comprising brush attachment means. The brush attachment means preferably can comprise a wire staple member 760 which has two ends 761, 762 which are inserted into the cover member 723.

Alternately, as shown in FIG. 22, the brush 742 can be mounted to the valve stem 723 by using an interference fit to maintain the member 760.

The embodiments of the herbicide device shown in FIGS. 10 through 20, are also utilized in accordance with the method described above, to apply the herbicide from the container to unwanted vegetation with the applicator. The applicator is provided to contact the unwanted vegetation. Preferably, the applicator can contact the stem or bark of the unwanted plant, and, once applied, will kill the unwanted vegetation.

Preferably, the reservoir and valve elements are comprised of a rigid material, such as, for example, unplasticized polyvinyl chloride (PVC), which is a substance having resistance to permeation action from herbicides or pesticides formulated in carrying oils. In addition to unplasticized polyvinyl chloride (PVC), other suitable materials may include polyethylene terephthalate (PET) resign, polyethylene terephthalate with cyclohexanedimethanol (PET-G) resin, nylon, NYALENE®, CONOLENE®, acrylonitrile methyl acrylate co-polymer (BAREX®), fluorinated polyethylene, fluorinated polypropylene, DELRIN®, LEXAN®, TEFLON®, stainless steel, aluminum, or tin.

For example, while shown herein comprising a brush, the applicator can comprise a sponge, natural or synthetic porous material, or other suitable element for delivering the herbicide to a plant. In the preferred embodiment shown herein, the bristles are provided to cover the aperture, while at the same time permit the flow of the herbicide onto the bristles for delivery to a plant.

While described as a herbicide device in the preferred embodiments, it will be understood that the present invention can also be useful for the control of crawling insects and other pests, and can include with or without the herbicide compound, one or more pesticide compounds for delivery with the device and method according to the present invention. For example, the herbicide compound can be painted on paths where no vegetation is desired, such as between concrete cracks and asphalt cracks. In addition, where the device employs a pesticide, the pesticide can be painted on the path where insects cross to control insects. For example, the type of insects which can be controlled by an application of pesticides from the device include crawling insects, such as ants, roaches, spiders, centipedes, millipedes, silverfish, etc. The types of pesticides which can be used to control such insects preferably can comprise contact pesticides, among which are Propoxur, diazinon, permethrin, cypermethrin, chlorpyrifos, and carbaryl. In addition, other substances may be utilized to lure insects into contact with the pesticide. These include pheremones (sex attractant), vanillins (food attractants) and several different pigments (color attractants).

These and other advantages of the present invention will be understood from a reading of the background of the invention, the summary of the invention, the brief description of the drawing figures, the detailed description of the preferred embodiments and the appended claims. The invention is intended to be broadly construed in accordance with the claims.

We claim:

1. A device for applying a herbicide or pesticide directly to a surface comprising:
(a) reservoir means for containing a herbicide or pesticide compound therein;
(b) a herbicide or pesticide compound placed in the reservoir means;
(c) applicator means for applying a herbicide compound directly to unwanted vegetation when the reservoir contains a herbicide compound or for applying a pesticide to a surface to control or eliminate insects or other crawling pests when the reservoir contains a pesticide;
(d) delivery means for delivering the herbicide or pesticide compound from said reservoir to said applicator means; and
(e) safety cover means for selectively covering the delivery means.

2. The device of claim 1, wherein said reservoir means comprises a reservoir with a neck, wherein said safety cover means comprises a cover member with an inner surface and an outer surface and having a depressable tab portion, and wherein associated tab stop means is disposed on said reservoir for selective engagement with said depressable tap portion, said depressable tab portion being selectively depressable to free it from engagement with the tab stop means.

3. The device of claim 2, wherein said safety cover means further comprises a lug ring disposed about said reservoir neck and a plurality of annular lugs provided on the inner surface of the cover member for engagement with the annular lug ring.

4. The device of claim 1, wherein said applicator means comprises a brush adapted to receive a flow of herbicide therethrough.

5. The device of claim 1, wherein said applicator means comprises an aperture.

6. The device of claim 1, wherein said delivery means includes means for sealingly containing the herbicide or pesticide compound within the reservoir means.

7. The device of claim 6, wherein said reservoir means comprises a reservoir having a neck, wherein said means for sealingly containing the herbicide compound comprises a first threaded portion disposed on said delivery means and a first matingly associated threaded portion disposed on said neck for sealingly connecting said delivery means and said reservoir, and a second threaded portion disposed on said delivery means and a second matingly associated threaded portion disposed on said neck for sealingly connecting said safety cover means and said reservoir.

8. The device of claim 7, wherein said reservoir neck is wider where said first matingly associated threaded portion is disposed and is narrower where said second matingly associated threaded portion is disposed.

9. The device of claim 1, wherein said delivery means comprises a valve unit with an opening therein to permit the passage of herbicide or pesticide compound therethrough.

10. The device of claim 3, wherein said delivery means comprises a valve unit having a valve stem and a twist valve which is rotatable relative to said valve stem and carries said applicator means, said twist valve having a range of positions arrived by rotating the twist valve relative to said valve stem to regulate the amount of flow of herbicide or pesticide compound from the reservoir.

11. The device of claim 2, further comprising gasket means between said delivery means and said reservoir means.

12. The device of claim 10, further comprising gasket means between said valve stem and said reservoir, wherein said neck has an inner surface and an outer surface, and wherein said gasket means comprises an annular flange provided on said valve stem and disposed for engagement with the inner surface of said reservoir neck.

13. The device of claim 10, wherein said valve stem has passage means therein.

14. The device of claim 13, wherein said passage means comprises a plurality of openings provided at one end of said valve stem.

15. The device of claim 10, wherein said valve unit has seal means for sealing the valve stem and twist valve.

16. The device of claim 15, wherein said valve seal means comprises an annularly disposed sealing flange provided on the valve stem, a first annular rim provided on the inner surface of the twist valve, and a second annular rim provided on the inner surface of the twist valve and spaced apart from said first annular rim, wherein said twist valve is rotatable mounted on said valve stem for vertical displacement over a predetermined range when said twist valve is rotated, where the annularly disposed sealing flange engages the first annular rim at one end of said range, and wherein said annularly disposed sealing flange engages the second annular rim at the other end of said range.

17. The device of claim 9, wherein said valve unit has valve closure means for closing off the flow of herbicide or pesticide from the reservoir.

18. The device of claim 17, wherein said valve closure means comprises a flow-blocking flange disposed on the inner surface of said twist valve and having an aperture therein.

19. The device of claim 18, wherein said valve stem has a tip configured for selective insertion of said tip through said aperture of the flow-blocking flange such that the flow blocking flange is movable in relation to said tip from a closed position where the tip is inserted through the aperture, to an opened position where the tip is clear of said aperture, there being a range of positions between said open position and said closed position wherein the partial blocking of said aperture by said tip occurs, the flow from said reservoir to said applicator means being regulated by the relative position of said valve stem tip and said flow-blocking flange

20. The device of claim 1, further comprising ratchet means for securing the delivery means to said reservoir means to prevent removal of said delivery means from said reservoir means.

21. The device of claim 10, further comprising a plurality of teeth disposed about said reservoir neck and a plurality of matingly associated ratchet teeth disposed on said valve stem.

22. A method for eliminating unwanted vegetation growth when a herbicide is used or for eliminating or controlling crawling pests such as insects when a pesticide is used, comprising the steps of: (a) providing a compound comprising a herbicide or pesticide compound in a reservoir; (b) selectively delivering the herbicide or pesticide compound from the reservoir to an applicator; (c) directly contacting a surface with the applicator; and (d) regulating the flow of said herbicide or pesticide delivered by said applicator to the surface, wherein the step of directly contacting a surface comprises contacting unwanted vegetation when a herbicide is provided in the reservoir, and wherein the step of directly contacting a surface comprises contacting a surface which crawling pests such as insects can cross when a pesticide is provided in the reservoir.

23. The method of claim 22, wherein the step of providing a herbicide in a reservoir comprises providing an oil based herbicide.

24. The method of claim 22, further including the step of securing said herbicide or pesticide compound in said reservoir with safety cover means, wherein the step of securing includes placing said cover means on said reservoir and rotating said cover means past a predetermined stop to block reverse rotation of said cover means.

25. The method of claim 24, further including the step of opening said cover means by applying force to a portion of said cover means to enable positive rotation of said cover means to release it from the reservoir.

26. The method of claim 22, wherein the step of selectively delivering the herbicide from the reservoir to an applicator comprises squeezing the reservoir to force the herbicide or pesticide compound through a regulatable valve.

27. The method of claim 22, further comprising the step of removing from the applicator an overcap which selectively covers the applicator.

28. The method of claim 22, further including the step of securing said herbicide or pesticide compound in said reservoir with safety cover means, wherein the step of securing, includes placing said cover means on said reservoir and rotating said cover means past a predetermined stop to block reverse rotation of said cover means.

29. The method of claim 28, further including the step of opening said cover means by applying force to a portion of said cover means to enable positive rotation of said cover means to release it from the reservoir.

30. The method of claim 22, wherein the step of selectively delivering the herbicide or pesticide compound from the reservoir to an applicator comprises squeezing the reservoir to force the herbicide or pesticide compound through a regulatable valve.

31. The device of claim 1, wherein said safety cover means further comprises a cover member having a rim with one or more interfering elements disposed on said rim, and wherein said reservoir means has lugs disposed thereon for engagement with said interfering elements when the cover member is installed on the container.

32. The device of claim 31, wherein said interfering elements are disposed on opposite circumferential sides of said rim, and wherein said lugs are disposed on said container proximate the neck of said container and being positioned circumferentially opposite to one another.

33. The device of claim 1, wherein said delivery means comprises a valve unit having a flange which is adapted for press fit connection of said valve unit with said reservoir means to connect said valve unit with said reservoir means.

34. The device of claim 1, wherein said valve unit comprises a twist valve.

35. The device of claim 33, wherein said valve unit comprises a first element and a second element, wherein said second element is movable relative to said first element from a first position which closes off the flow of fluid to prevent fluid exit from said valve unit and a second position wherein fluid contained in said reservoir means is permitted to flow through said valve unit to said applicator means.

36. A device for applying herbicides and/or pesticides to a surface.

37. The device of claim 36, wherein the herbicide or pesticide is of a fluid, semi-fluid, viscous, foamed, powdered, granulated, or any other conductive physical form.

38. The device of claim 36, wherein the device is so constructed as to apply the herbicide or pesticide directly to a surface, without aerial transmission of the herbicide or pesticide.

39. The device of claim 36, wherein an applicator/closure for dispensing and applying such a herbicide or pesticide and a reservoir for containing same are combined in a single structure.

40. The device of claim 39, wherein the applicator/closure has the ability to selectively contain the herbicide and/or pesticide within the reservoir, and also to dispense same from same.

41. The device of claim 39, wherein the applicator/closure effects the dual abilities of containment and dispensation by means of a mechanism.

42. The device of claim 41, wherein, in the preferred embodiment, the applicator mechanism is comprised of an internally conductive twist valve unit with a series of internal threads which engage upon a complementary series of threads which are an integral part of an internally conductive valve stem upon which the twist valve is mounted, this valve stem comprising the closure of the reservoir, in such a manner as that when the twist valve is rotated into a certain position relative to the valve stem (i.e. “closed”) the spatial relationship between the twist valve and the valve stem forms a physical barrier which prevents the escape of the herbicide or pesticide from the reservoir, while this same twist valve, when rotated into an alternate position relative to the valve stem (i.e. “open”) will allow the contents of the reservoir to flow out of the reservoir through a path defined by the structure of the valve mechanism and the applicator tip.

43. The device of claim 41, wherein the valve mechanism has the ability to selectively modulate the rate of flow of the contents of the reservoir by altering the physical relationship between the twist valve and the valve stem in such a manner as that the internal aperture through which the contents may flow may either increase or decrease in size, so that the operator may increase or decrease the said rate of flow in a discretionary manner.

44. The device of claim 41, wherein the dispensing orifice of the valve mechanism comprises an applicator tip which has the ability to conduct a herbicide or pesticide through or over its structure and onto a surface when the valve mechanism is opened and said applicator tip is brought into contact with said surface.

45. The device of claim 44, wherein, in the preferred embodiment, the applicator tip takes the form of a brush with bristles or filaments, which are secured within a ferrule that has an orifice in its structure for allowing the flow of materials through the ferrule for dispensation by the bristles or filaments.

46. The device of claim 41, wherein, in an alternate embodiment, the applicator mechanism is comprised of an internally conductive pull-push valve, which is constructed to permit its vertical motion upon an internally conductive valve stem, which comprises the closure of the reservoir; said pull-push valve having such an abilities and features as those described in claims 40, 41, and 43, and also having such a dispensing applicator tip as described in claims 44 and 45, and having in the interior of its dispensing orifice a valve seal which interacts with a valve plug which is located at the exterior of the dispensing orifice of the valve stem in such a manner as that when the pull-push valve is placed into its lowest position in relationship to the valve stem (i.e. “closed”) the valve plug acts to obstruct the flow of said materials through the valve seal, whereupon when the pull-push valve is placed into a higher position relative to the valve stem (i.e. “open”) the spatial relationship between the pull-push valve and the valve stem will permit the flow of said materials out of the reservoir through a path defined by the structure of the valve mechanism and the applicator tip.

47. The device of claim 36, wherein the applicator/closure section is enclosed by an overcap so constructed as to resist its removal by a child.

48. The device of claim 47, wherein, in the preferred embodiment, The child-resistant overcap takes the form of an inner annular enclosing section bearing upon the interior surface of its lower aspect a series of threads which engage upon a complementary series of threads which are an integral part of the neck portion of the reservoir, the clockwise and counter-clockwise motion of said threaded portion of the overcap upon said neck threads allowing for the respective closure and removal of said overcap; and which also has an outer annular deflectable lug skirt section which carries at opposing points upon the underside of its bottom edge 2 lugs which engage against a complementary set of 2 lug stops which are an integral part of the neck portion of the reservoir, said lug stops acting to prevent removal of the overcap by a child by obstructing the path of the overcap lugs when the overcap is subjected to counter-clockwise motion for removal without the concurrent action of applying an internally-directed pressure or squeezing action upon said annular deflectable lug skirt on opposing sides of said lug skirt at points which are situated at a 90° angle from the lugs, said squeezing action at said points causing the deflectable lug skirt to assume an ovoid profile in such a manner as that the apexes of said ovoid profile of the deflectable lug skirt shall form at the points which carry the lugs on the underside of the bottom edge, this action causing said lugs to extend outward to a position beyond the area of obstruction of the counter-clockwise travel path of said lugs created by the presence of the lug stops on the neck, and thereby allowing for the removal of the overcap; the simultaneous execution of both the counter-clockwise rotation of the overcap and the squeezing action of the deflectable lug skirt being established as exceeding the capabilities of a child of an age determined to be unsuitable for safe operation of a product of this type.

49. A device for applying a liquid directly to a surface,
comprising:
(a) reservoir means for containing a liquid compound therein;
(b) a liquid compound placed in the reservoir means;
(c) applicator means for applying a liquid compound directly to a surface when the reservoir contains a liquid compound;
(d) delivery means for selectively delivering the liquid compound from said reservoir to said applicator means; and
(e) channel means for minimizing leakage of the liquid from the delivery means.

50. The device of claim 49, wherein said delivery means comprises a valve unit comprising a valve stem and a cover element slidably mounted on said valve stem.
